(19) United States
(12) Patent Application Publication
(10) Pub. No.: US 2025/0021402 A1
(43) Pub. Date: Jan. 16, 2025

(54) DYNAMIC CLUSTER MEMBER ROLE SELECTION BASED ON AVAILABLE RESOURCES

(71) Applicant: Dell Products L.P., Round Rock, TX (US)

(72) Inventors: Chris Stacey, Seattle, WA (US); Edward H. Yardumian, Medina, WA (US)

(21) Appl. No.: 18/351,006

(22) Filed: Jul. 12, 2023

(51) Int. Cl. G06F 9/50

(52) U.S. Cl. CPC G06F 9/5083

(57) ABSTRACT

A method for dynamic cluster member role selection based on available resources includes monitoring, by a system including a processor, operational states of resource elements of a computing device in a computing cluster. The method also includes, in response to determining, via the monitoring, that a first resource element of the resource elements has transitioned between a functioning operational state and a non-functioning operational state, assigning, by the system, a computational function to the computing device based on second resource elements, of the resource elements, having the functioning operational state.

### BACKGROUND

In a multi-node clustered information technology (IT) solution such as a network attached storage (NAS) system, a group of individual servers or other computing devices, referred to as system nodes, can communicate over a backend network to form a cluster where the respective nodes of the cluster share resources such as storage, processing capacity, etc. Respective system nodes in a cluster deployment can participate in a variety of different roles, such as user data storage, backup coordination, or the like. To this end, a system node can be equipped with computing resources, such as specific physical and/or virtual hardware resources, software resources, or the like, to enable the node to perform the functions of its assigned role.

### SUMMARY

The following summary is a general overview of various embodiments disclosed herein and is not intended to be exhaustive or limiting upon the disclosed embodiments. Embodiments are better understood upon consideration of the detailed description below in conjunction with the accompanying drawings and claims.

In an implementation, a system is described herein. The system can include a memory that stores executable components and a processor that executes the executable components stored in the memory. The executable components can include a resource monitoring component that determines operational statuses of resource components of a node device operating in a computing cluster associated with the system. The executable components can also include a role selection component that selects an operational role for the node device in response to the resource monitoring component identifying a change to a first operational status, of the operational statuses and corresponding to a first resource component of the resource components. The operational role can be selected by the role selection component based on second resource components, of the resource components, that are determined by the resource monitoring component to be operational. Additionally, the operational role can specify operations to be performed by the node device in the computing cluster.

In another implementation, a method is described herein. The method can include monitoring, by a system including a processor, operational states of resource elements of a computing device in a computing cluster. The method can further include, in response to determining via the monitoring that a first resource element of the resource elements has transitioned between a functioning operational state and a non-functioning operational state, assigning, by the system, a computational function to the computing device based on second resource elements, of the resource elements, having the functioning operational state.

In an additional implementation, a non-transitory machine-readable medium is described herein that can include instructions that, when executed by a processor, facilitate performance of operations. The operations can include tracking performance metrics for resources associated with a node device of a computing cluster; determining, via the tracking, that a resource of the resources has transitioned between a functional state and a non-functional state; and in response to the determining, causing the node device to perform a first function, the first function being different from a second function performed by the node device before the determining.

### DESCRIPTION OF DRAWINGS

Various non-limiting embodiments of the subject disclosure are described with reference to the following figures, wherein like reference numerals refer to like parts throughout unless otherwise specified.

FIG. 1 is a block diagram of a system that facilitates dynamic cluster member role selection based on available resources in accordance with various implementations described herein.

FIG. 2 is a diagram depicting example roles that can be performed by a node device in a computing cluster in accordance with various implementations described herein.

FIG. 3 is a block diagram of a system that facilitates reselecting a role assigned to a node device in a computing cluster in accordance with various implementations described herein.

FIG. 4 is a diagram depicting example operations that can be performed by a node device in response to a storage media failure in accordance with various implementations described herein.

FIG. 5 is a diagram depicting an example multidimensional role structure that can be utilized by various implementations described herein.

FIG. 6 is a block diagram of a system that facilitates role definition and selection for a computing node in a cluster in accordance with various implementations described herein.

FIG. 7 is a block diagram of a system that facilitates loading-initiated dynamic cluster member role selection in accordance with various implementations described herein.

FIGS. 8-9 are flow diagrams of respective methods that facilitate dynamic cluster member role selection based on available resources in accordance with various implementations described herein.

FIG. 10 is a diagram of an example computing environment in which various implementations described herein can function.

### DETAILED DESCRIPTION

Various specific details of the disclosed embodiments are provided in the description below. One skilled in the art will recognize, however, that the techniques described herein can in some cases be practiced without one or more of the specific details, or with other methods, components, materials, etc. In other instances, well-known structures, materials, or operations are not shown or described in detail to avoid obscuring subject matter.

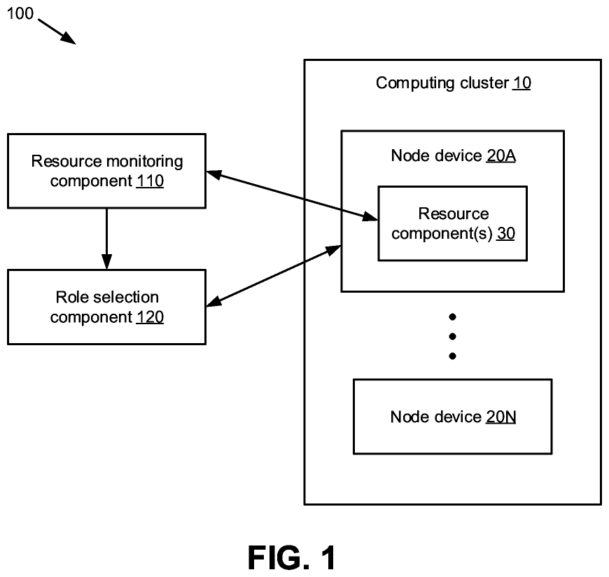

With reference now to the drawings, FIG. 1 illustrates a block diagram of a system 100 that facilitates that facilitates dynamic cluster member role selection based on available resources in accordance with various implementations described herein. System 100 as shown in FIG. 1 includes a resource monitoring component 110 and a role selection component 120, which can operate as described in further detail below to facilitate management of a computing cluster 10 and/or its respective node devices 20. While the resource monitoring component 110 and role selection component 120 are shown in FIG. 1 as separate from the computing cluster 10 and its node devices 20, it is noted that these components 110, 120 could be implemented on one or more node devices 20 of the computing cluster 10 and/or other suitable devices, such as an orchestration server that manages operation of the computing cluster 10. Additionally, while the computing cluster 10 is illustrated as having N node devices 20A-20N, it is noted that the node devices 20 are shown in FIG. 1 merely for illustrative purposes and are not intended to limit the computing cluster 10 to any particular number of node devices 20. Further, the naming convention utilized for node devices 20A-20N is not intended to imply any specific number of node devices 20, as the computing cluster 10 could, in some implementations, include any number of node devices 20, including one node device 20 or multiple node devices 20.

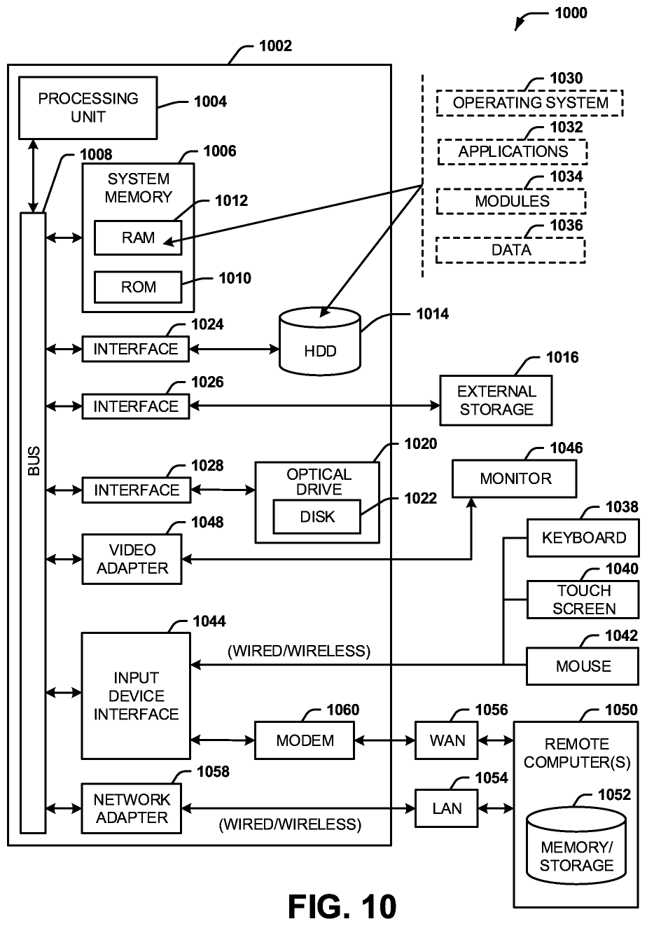

In an implementation, the components 110, 120 of system 100 can be implemented in hardware, software, or a combination of hardware and software. By way of example, the components 110, 120 can be implemented as computer-executable components, e.g., components stored on a memory and executed by a processor. An example of a computer architecture including a processor and a memory that can be used to implement the components 110, 120, as well as other components as will be described herein, is shown and described in further detail below with respect to FIG. 10.

In an implementation, the node devices 20 of the computing cluster 10 can communicate with each other via a backend network, e.g., an InfiniBand (IB) or Ethernet network or the like, over which the node devices 20 can share resources, make shared storage available to clients, and/or perform other tasks. The number of node devices 20 in the computing cluster 10 can vary depending on use case and/or client needs. For instance, a typical cluster can contain between 3 to approximately 250 node devices 20.

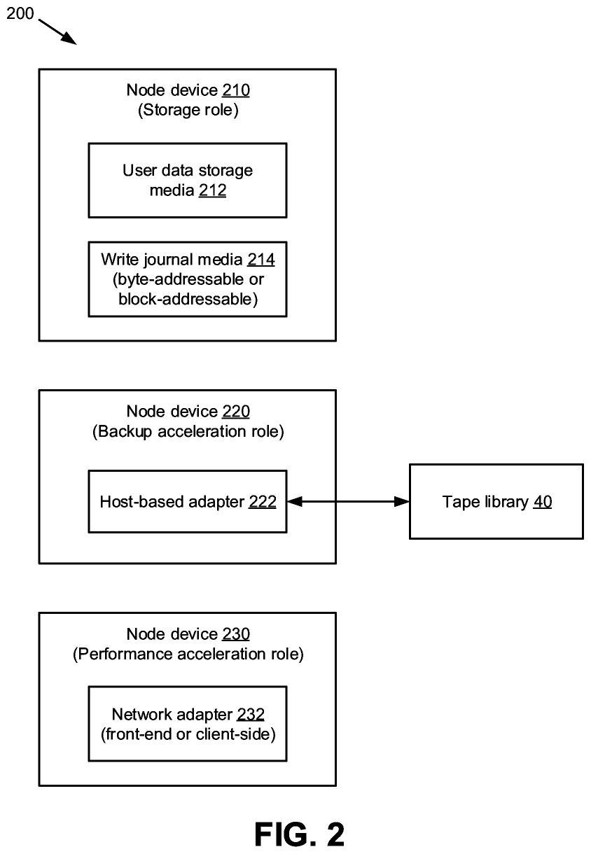

Within the computing cluster 10 shown in FIG. 1, each of the node devices 20 can perform operations associated roles assigned to the node devices 20. By way of example, a node device 20 can be a storage node, an accelerator node, and/or other node types based on the resource components 30 that are available to that particular node device 20. Examples of various roles that can be performed by a node device 20, as well as resource components 30 associated with those roles, are described in further detail below with respect to FIG. 2. As used herein, the terms “resource,” “resource component,” “resource element,” or the like are intended to refer to both hardware resources as well as software resources. The term “hardware resource” as used herein refers to a hardware device or element, such as a storage drive, a memory module, a processor, etc., that can be utilized by a node device 20, and can include both real hardware elements and virtual hardware elements, i.e., components of virtual hardware associated with a virtual node in a cloud deployment. The term “software resource” as used herein refers to any software application, module, service, or the like that can be utilized by a node device 20.

While various examples provided herein relate to a storage cluster, it is noted that these examples are provided merely for purposes of description and that similar concepts could apply to any clustered computing deployment in which the roles and/or activities that a given node performs are governed by the hardware and/or software resources available to that node.

In a traditional system, cluster nodes are purpose built with hardware and/or software components corresponding to a fixed, given role to be performed by the node. By way of example, a cluster node can be built with storage media and assigned a storage role based on the node's hardware and/or software configuration. However, in such a system, if the resources required for the node to perform its role are not available (e.g., due to those resources failing), the node ceases to function. Any mismatch between the resources expected for the role a node is configured to play and the resources available to it must then be resolved before the node can resume functionality. This, in turn, limits the flexibility of system administrators to deploy software onto hardware of their choosing. Additionally, fixed role nodes can present problems in a virtual environment in which virtualized system nodes can change their available hardware and/or software at will.

To the furtherance of the above and/or related ends, various implementations described herein can enable node devices to select and/or change their role dynamically based on the hardware and/or software available to them, e.g., either on boot or as hardware and/or software availability changes during runtime. In doing so, the implementations described herein can increase deployment flexibility and node availability, especially in public and/or private cloud environments that utilize virtualized hardware and/or software resources.

With reference now to the components shown in FIG. 1, the resource monitoring component 110 can determine operational statuses of resource components 30 of a node device 20 operating in a computing cluster 10 associated with system 100. For instance, the resource monitoring component 110 can track performance metrics and/or other information relating to the operational states of the resource components 30 of a node device 20 to detect changes to the availability of the resource components 30. It is further noted that the resource components 30 associated with the node device 20 are distinct from the logical components used in this description, e.g., the components 110, 120 and other logical components as will be described herein. A resource component 30 of a node device 20 can also be referred to as a resource element, a resource, and/or other terminology.

In an implementation, the resource monitoring component 110 can determine, based on monitoring the performance of the resource components 30 of a node device 20, that the availability of one or more resource components 30 has changed. For instance, the resource monitoring component 110 can identify a change to an operational status of a first one of the resource components 30 of the node device 20, e.g., as a result of that resource component 30 becoming non-operational after previously being operational, or vice versa. A change in the operational status of a resource component 30 can occur, e.g., in response to the node device 20 booting up and connecting to the computing cluster 10, as a result of which all resource components 30 of the node device 20 can be considered as becoming operational. Alternatively, the operational status of a resource component 30 can occur as a result of a failure of a resource component 30, a change in network or device policy, and/or based on any other suitable event.

The role selection component 120 of system 100 can, in response to the resource monitoring component 110 identifying a change to the operational status of a resource component 30 of the node device 20 (e.g., based on the resource component 30 transitioning between a functional state and a non-functional state as described above), select (or re-select) an operational role for the node device 20. In an implementation, a role selected by the role selection component 120 for a node device 20 can be determined based on second resource components 30 of the node device 20 that are determined by the resource monitoring component 110 to be operational. Stated another way, the role selection component 120 can assign a role to be performed by a given node device 20 based on hardware and/or software resources available to that node device 20, which may be the same as, or different from, the resources that triggered operation of the role selection component 120 by becoming functional or non-functional.

In an implementation, the operational role selected by the role selection component 120 can specify and/or otherwise be associated with operations to be performed by a node device 20 having that operational role. Examples of roles that can be performed by a node device 20 and their associated operations are described in further detail below with respect to FIG. 2.

By utilizing the resource monitoring component 110 and role selection component 120 shown in FIG. 1, system 100 can treat the role that a node plays in a multi-role solution as a function of the resources available to that node. The resources available to a node, and hence the role assigned to that node, can be determined at boot time and/or changed in response to a change in available resources. As a result, system 100 can increase deployment flexibility and solution availability for a clustered computing system, especially in public and private cloud environments.

Referring now to FIG. 2, diagram 200 depicts example roles that can be performed by a node device in a computing cluster, e.g., a node device 20 in a computing cluster 10 as described above with respect to FIG. 1. It is noted that the roles shown in diagram 200 and their associated resource elements are provided merely as examples. More particularly, a node device performing a given role could utilize hardware and/or software resources that differ from those shown in diagram 200, and a node device could also perform roles that are not shown in diagram 200 in addition to, or in place of, the depicted roles. Additionally, while each role is shown in diagram 200 with respect to a separate node device for simplicity of illustration, it is noted that a given node device could perform at least some of the functionality of multiple roles simultaneously in some implementations.

Node device 210 shown in diagram 200 is an example of a storage node, e.g., a node device that is assigned a storage role and/or otherwise performs storage functions. The resources of the node device 210 that are associated with the storage role can include user data storage media 212 and write journal media 214. The user data storage media 212 can be any suitable storage medium (e.g., non-transitory storage media), such as hard disk drives (HDDs), solid state drives (SSDs), or the like, and can be used to store user (client) data managed by a clustered data storage system in which the node device 210 operates.

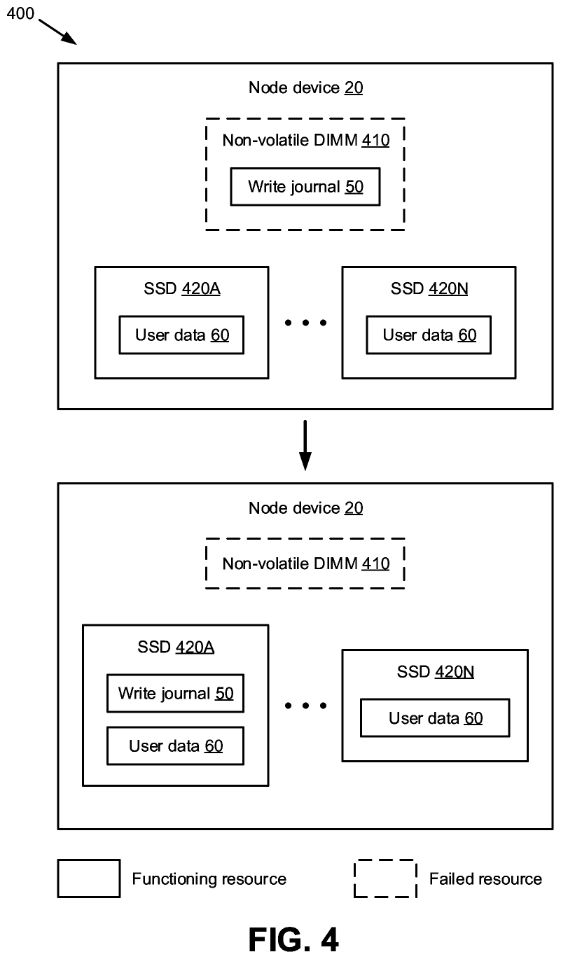

The write journal media 214 of the node device 210 can be utilized to store a write journal that records operations performed with respect to user data stored by the node device 210, e.g., for purposes of error recovery, data verification, or other purposes. As shown in diagram 200, the write journal media 214 can be either byte-addressable media, such as a non-volatile dual inline memory module (NVDIMM) and/or other non-volatile random access memory (NVRAM) devices, or block-addressable media, such as an HDD or SSD. In some implementations, the storage role shown in diagram 200 can be subdivided into sub-roles based on whether a given node utilizes byte-addressable storage or block-addressable storage for its write journal. An example in which a node device switches between these sub-roles is described in further detail below with respect to FIG. 4. In further implementations, the write journal can be stored on one or more storage devices that also store user data, and disk partitions and/or other mechanisms can be utilized to separate the user data from journal data.

Node device 220 shown in diagram 200 is an example of a backup node, e.g., a node device that is assigned a backup acceleration role and/or otherwise performs backup-related functions. To this end, the node device 220 can have resources associated with the backup acceleration role that include a host-based adapter (HBA) 222 and/or another adapter device that enables a direct connection between the node device 220 and a tape library 40. In some implementations, the HBA 222 is a FC HBA, e.g., provided via a FC network card, that enables a high-speed FC connection between the node device 220 and the tape library 40. The tape library 40 can be a physical tape library, e.g. composed of magnetic tapes and/or tape drives, or a virtual tape library, e.g., composed of HDDs and/or other storage media that emulate magnetic tapes and/or tape drives.

Node device 230 shown in diagram 200 is an example of a performance acceleration node, e.g., a node device that is assigned a performance acceleration role and/or otherwise performs functions related to processing assistance. As shown in diagram 200, a node device can be given the performance acceleration role provided it has a functioning network adapter 232, e.g., that provides a front-end or client-side network connection. This network connection can be used to assist other node devices in serving client connections, e.g., by utilizing processing, memory, and/or other resources of the node device to perform tasks associated with other connected node devices, thereby accelerating and/or adding performance of an associated cluster.

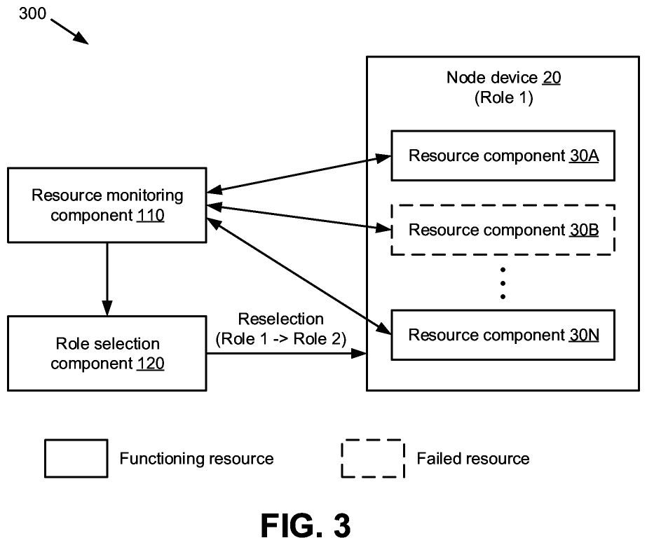

With reference next to FIG. 3, a block diagram of a system 300 that facilitates reselecting a role assigned to a node device 20 in a computing cluster 10 is illustrated. Repetitive description of like parts described above with regard to other implementations is omitted for brevity. System 300 as shown in FIG. 3 includes a node device 20, which can operate as part of a computing cluster (not shown in FIG. 3) in a similar manner to that described above with respect to FIG. 1. The node device 20 includes respective resource components (elements, resources) 30, here N resource components 30A-30N, which can be utilized by the node device 20 to perform various functions and/or roles. It is noted that the naming convention utilized for the resource components 30 is merely for illustrative purposes and is not intended to imply any specific number of resource components 30.

As further shown in FIG. 3, the node device 20 can initially perform a first role, denoted in FIG. 3 as Role 1, based on the resource components 30 that are available to the node device 20 at a time prior to that depicted by FIG. 3. For instance, the node device 20 can, either independently or with the aid of the resource monitoring component 110 and role selection component 120, assume Role 1 and its associated functions at the time the node device 20 boots and/or connects to an associated cluster, e.g., based on the resource components 30 of the node device 20 that are functional at that time.

As additionally shown by FIG. 3, in the event that the availability of the resource components 30 of the node device 20 changes, e.g., due to a resource component 30B failing and/or otherwise transitioning from an operational state to a non-operational state, the resource monitoring component 110 can relay information regarding this change to the role selection component 120, and the role selection component 120 can utilize this information to select an updated role for the node device 20, denoted in FIG. 3 as Role 2, based on the remaining available hardware and/or software resources of the node device 20. As a result of changing from Role 1 to Role 2, the node device 20 can be configured to perform functions and/or operations that differ from functions and/or operations that were previously performed by the node device 20, e.g., while the node device 20 was associated with Role 1.

In some implementations, in the event that multiple operational roles are supported by the available resource components 30 of the node device 20 at the time shown by FIG. 3, the role selection component 120 can select the operational role to be assigned to the node device (e.g., Role 2) based on a decision tree and/or other logic that assigns relative priorities to respective roles based on configurable administrative policies that specify preferred roles, system performance metrics, and/or other factors. In some cases, the role selection component 120 can select all, or a subset of, the possible roles for the node device 20 based on the above and/or other considerations.

While FIG. 3 illustrates an example of role reselection being triggered by the failure of a resource component 30B, it is noted that the role selection component 120 can change the role assigned to a node device 20 based on additional or alternative factors. By way of example, operation of the role selection component 120 as shown in FIG. 3 can be initiated based on a change to an administrative configuration associated with system 300. Such a change can be specific to the node device 20 and/or generic to a cluster in which the node device 20 operates. An example of the latter case could include a change to a configuration that specifies a desired proportion of storage nodes, e.g., node devices 210 as shown in FIG. 2, relative to a number of performance acceleration nodes, e.g., node devices 230 as shown in FIG. 2, in the system. By way of an additional example in which the node device 20 is a virtual machine, operation of the role selection component 120 can be initiated based on a change to the emulated hardware associated with the node device 20. Other triggering events are also possible.

In some implementations, the role selection component 120 can select or reselect a role assigned to a given node device 20 in an automated manner, e.g., based on occurrence of a triggering event as described above. In other implementations, a system administrator or other system user can manually direct operation of the role selection component 120, either wholly or in part.

Referring now to FIG. 4, and with further reference to FIG. 3, diagram 400 depicts example role reselection operations that can be performed by the role selection component 120 of FIG. 3 for a node device 20 operating as a storage node based on the failure of an NVDIMM 410 that stores a write journal 50. As shown by diagram 400, the node device 20 can initially store its write journal on the NVDIMM 410, e.g., based on an initial configuration of the node device 20. In response to the NVDIMM 410 being determined to have failed, the node device can shift the write journal from the byte-addressable NVDIMM 410 to block-addressable media, such as an SSD 420 that stores user data 60 maintained by the node device 20.

In the example shown by diagram 400, an SSD, e.g., SSD 420A shown in diagram 400, can assume responsibility for maintaining the write journal 50. While diagram 400 illustrates that SSD 420A continues to maintain user data 60 in addition to the write journal 50, in some implementations the user data 60 maintained by SSD 420A can be transferred to other SSDs of the node device, e.g., SSD 420N shown in diagram 400, once SSD 420A begins storing the write journal 50.

As an alternative to the transition from byte-addressable journal media to block-addressable journal media shown by diagram 400, other actions could be taken, e.g., by the role selection component 120 of FIG. 3, in response to failure of the NVDIMM 410. For instance, in response to the resource monitoring component 110 of FIG. 3 determining that the node device 20 has an interface to a tape library unit (e.g., a tape library 40 as shown in FIG. 2) and that the interface is operational, the role selection component 120 can reconfigure the system node 20 as a backup node. As another example, the role selection component 120 could reconfigure the system node 20 as a processing assistance node in response to the resource monitoring component 110 determining that the node device 20 has a functional network connection.

While diagram 400 illustrates an example in which byte-addressable journal media of a system node 20 fails, similar operations could be performed by the role selection component 120 for a system node that utilizes block-addressable journal media. For instance, if the write journal 50 shown by diagram 400 was initially stored by SSD 420A, the role selection component 120 could configure another SSD of the node device 20 that stores user data 60, e.g., SSD 420N, to store the write journal 50 in addition to, or in place of, user data 60. As another example, the operations shown in diagram 400 could occur in reverse, e.g., by moving the write journal 50 for the system node 20 from SSD 420A to an NVDIMM 410 in response to the NVDIMM 410 being installed (either physically or virtually) at the node device 20 and/or the NVDIMM 410 otherwise becoming operational.

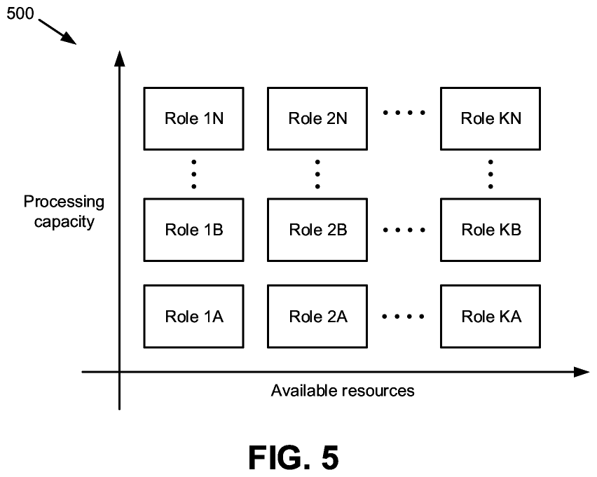

Turning next to FIG. 5, a diagram 500 depicting an example multidimensional role structure that can be utilized by various implementations described herein is illustrated. More particularly, diagram 500 illustrates a multi-dimensional role structure that can consider the processing capacity of a given node (e.g., in terms of processor power or capacity, memory capacity, etc.) in addition to available hardware and/or software resources in role selection. Diagram 500 illustrates a structure that includes K operational roles and N processing capacity roles, and the overall role assigned to a given node is designated by the coordinates of those two roles in the structure. It is noted that the naming conventions applied to the operational roles and processing capacity roles are provided merely for illustrative purposes and are not intended to imply any specific number of roles. Additionally, while the different roles are presented in diagram 500 as a grid for simplicity of illustration, each role depicted in diagram 500 can correspond to different discrete sets of resource components, e.g., the groups of resource components discussed above with respect to the roles depicted by FIG. 2, rather than a continuum of resources.

In some implementations, the processing capacity roles shown in diagram 500 can correspond to tiers or classes of processing capacity. For instance, node devices with a first amount of (physical or virtual) processing and/or memory resources can be associated with tier A shown in diagram 500, node devices with a second, higher amount of processing and/or memory resources can be associated with tier B, and so on. In the event that the processing and/or memory capability of a given device being changed (e.g., due to a processor upgrade, adding new memory, memory failure, etc.), the device can be moved to another tier as appropriate.

The processing capacity tiers shown in diagram 500 can be utilized (e.g., by a role selection component 120 as shown in FIG. 1) to assign roles and/or tasks to a node device operating in a cluster on the basis of computing resources available to the node device in addition to, or in place of, availability of hardware and/or software components as described above. For example, the role of a node can be selected such that the node is instructed to serve client connection traffic or not, or to manage locks within the system or not, based on the memory and/or central processing unit (CPU) available to the node. In one example with reference to diagram 500, node devices in processing capacity tier A could be assigned a role that excludes client connection and/or lock management operations, while node devices in higher processing capacity tiers, e.g., processing capacity tier B, could be assigned a role that includes those operations.

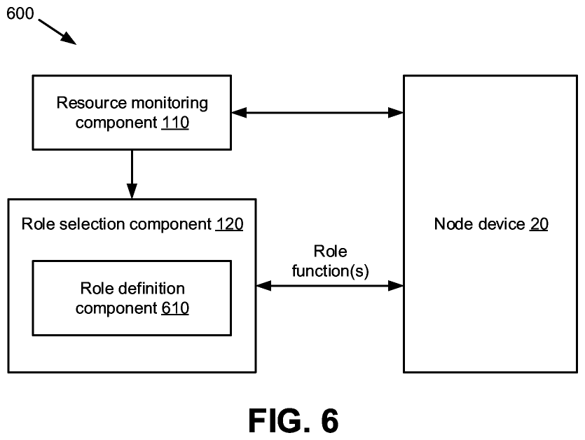

Referring next to FIG. 6, a block diagram of a system 600 that facilitates role definition and selection for a computing node in a cluster is illustrated. Repetitive description of like parts described above with regard to other implementations is omitted for brevity. System 600 as shown in FIG. 6 includes a resource monitoring component 110 and a role selection component 120 that can operate to assign an operational role to a node device 20 as described above. The role selection component 120 of system 600 includes a role definition component 610, which can associate respective operations or tasks with a given operational role, either generally or with respect to specific node devices 20.

By way of example, the role definition component 610 can configure a subset of node devices 20 in a given cluster to handle lock management, either based on the operational roles of the node devices 20 and/or the processing capacity available to a given node device 20 (e.g., as described above with respect to FIG. 5). For instance, the role definition component 610 can exclude lock management operations from a processing role, e.g., as assigned to a node device 230 as shown in FIG. 2, while including lock management operations in other roles. This can be done, e.g., to enable a node device with a processing role to join and/or leave the cluster with minimal disruption to other node devices.

Other considerations can also be utilized by the role definition component 610 for defining tasks to be assigned to a given node device 20. As an example, a node device 20 that has no interface for client connections can be excluded by the role definition component 610 from handling client traffic. Also or alternatively, a node device 20 can be allocated client connections conditionally, e.g., based on the amount of processing capacity available to the node device 20. For instance, a node device 20 can be configured to handle client connections based on the node device 20 having at least a threshold amount of processing capacity. If the node device 20 subsequently falls below the threshold amount of processing capacity, the node device 20 can be instructed by the role definition component 610 to cease handling client connections.

In some implementations, operation of the role definition component 610 can also be driven by system policies. By way of example, a system could have a policy in which a minimum of three system nodes are to serve front-end client connection traffic at all times. In this example, the role definition component 610 could override other rules, e.g., based on processing capacity or the like, to allocate client connections to a given system node 20 to fulfill the associated policy even if that node would otherwise not qualify for client connections. Other considerations are also possible.

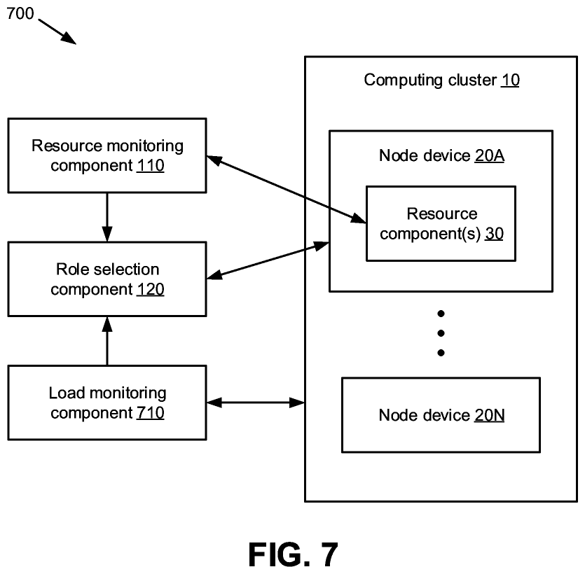

With reference next to FIG. 7, a block diagram of a system 700 that facilitates loading-initiated dynamic cluster member role selection is illustrated. Repetitive description of like parts described above with regard to other implementations is omitted for brevity. System 700 as shown in FIG. 1 can operate in a similar manner to system 100 as described above with respect to FIG. 1, with the addition of a load monitoring component 710 that can monitor a load level of the computing cluster 10. Here, operation of the role selection component 120 can be at least partially load-driven, such that the role selection component 120 can select an operational role for a given node device 20 in response to the load level of the computing cluster 10, e.g., as monitored by the load monitoring component 710, being determined to be greater than a loading threshold.

In some implementations, the load monitoring component 710 can perform additional cluster management operations in addition to guiding operation of the role selection component 120. By way of example, if the load monitoring component 710 determines that system load associated with the computing cluster 10 is becoming undesirably high, the load monitoring component 710 can increase the resources available to the computing cluster 10, e.g., by initiating an automated event that could add new system nodes 20 to the computing cluster 10, increasing the CPU and/or memory available to system nodes 20 (e.g., in an implementation that utilizes virtual hardware resources), or the like. Other operations could also be performed.

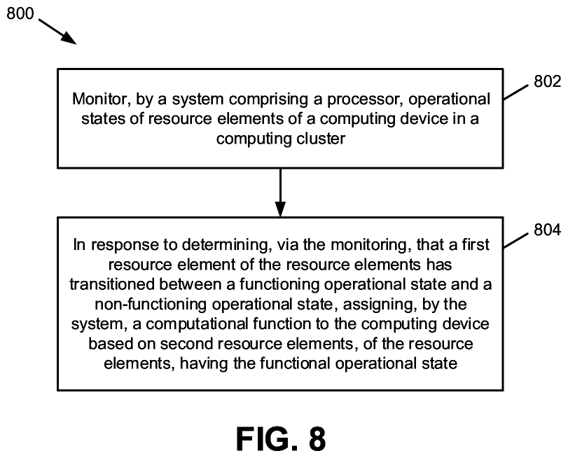

Turning now to FIG. 8, a flow diagram of a method 800 that facilitates dynamic cluster member role selection based on available resources is illustrated. At 802, a system comprising a processor can monitor (e.g., via a resource monitoring component 110) operational states of resource elements (e.g., resource components 30) of a computing device (e.g., a node device 20) in a computing cluster (e.g., a computing cluster 10).

At 804, in response to determining via the monitoring performed at 802 that a first resource element of the resource elements has transitioned between a functional operational state and a non-functional operational state, the system can assign (e.g., via a role selection component 120) a computational function to the computing device based on second resource elements, of the resource elements, having the functional operational state. Here, the second resource elements may, or may not, include respective ones of the first resource elements.

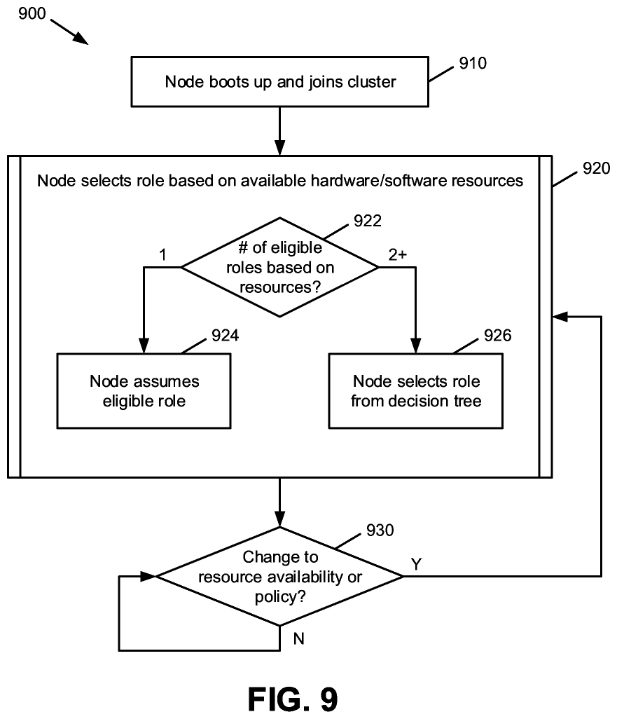

Referring next to FIG. 9, a flow diagram of another method 900 that facilitates dynamic cluster member role selection based on available resources is illustrated. Method 900 begins at 910, in which a node (e.g., a system node 20) boots up and joins a cluster (e.g., a computing cluster 10).

Method 900 proceeds from 910 to sub-method 920, in which the node selects a role based on its available hardware and/or software resources. As shown in sub-method 920, the node can determine the number of roles it is eligible to perform at 922 based on the resources available to the node. If the node is eligible for only a single role, sub-method 920 proceeds to 924, in which the node assumes the eligible role. If the node is eligible for multiple roles, sub-method 920 instead proceeds to 926, in which the node selects a role to perform, e.g., based on a decision tree. While not shown in FIG. 9, if the node is not eligible for any roles, sub-method 920 can conclude without selecting a role.

Upon completion of sub-method 920, method 900 proceeds to 930, in which the node determines whether changes have occurred to either the available resources of the node or any policies that impact role selection. If no changes have occurred, method 900 remains at 930 to monitor for further changes. Alternatively, in response to a change occurring, method 900 returns to sub-method 920 from 930 to enable the node to re-select its role.

FIGS. 8-9 as described above illustrate methods in accordance with certain embodiments of this disclosure. While, for purposes of simplicity of explanation, the methods have been shown and described as series of acts, it is to be understood and appreciated that this disclosure is not limited by the order of acts, as some acts may occur in different orders and/or concurrently with other acts from that shown and described herein. For example, those skilled in the art will understand and appreciate that methods can alternatively be represented as a series of interrelated states or events, such as in a state diagram. Moreover, not all illustrated acts may be required to implement methods in accordance with certain embodiments of this disclosure.

In order to provide additional context for various embodiments described herein, FIG. 10 and the following discussion are intended to provide a brief, general description of a suitable computing environment 1000 in which the various embodiments of the embodiment described herein can be implemented. While the embodiments have been described above in the general context of computer-executable instructions that can run on one or more computers, those skilled in the art will recognize that the embodiments can be also implemented in combination with other program modules and/or as a combination of hardware and software.

Generally, program modules include routines, programs, components, data structures, etc., that perform particular tasks or implement particular abstract data types. Moreover, those skilled in the art will appreciate that the various methods can be practiced with other computer system configurations, including single-processor or multiprocessor computer systems, minicomputers, mainframe computers, Internet of Things (IoT) devices, distributed computing systems, as well as personal computers, hand-held computing devices, microprocessor-based or programmable consumer electronics, and the like, each of which can be operatively coupled to one or more associated devices.

The illustrated embodiments of the embodiments herein can be also practiced in distributed computing environments where certain tasks are performed by remote processing devices that are linked through a communications network. In a distributed computing environment, program modules can be located in both local and remote memory storage devices.

Computing devices typically include a variety of media, which can include computer-readable storage media, machine-readable storage media, and/or communications media, which two terms are used herein differently from one another as follows. Computer-readable storage media or machine-readable storage media can be any available storage media that can be accessed by the computer and includes both volatile and nonvolatile media, removable and non-removable media. By way of example, and not limitation, computer-readable storage media or machine-readable storage media can be implemented in connection with any method or technology for storage of information such as computer-readable or machine-readable instructions, program modules, structured data or unstructured data.

Computer-readable storage media can include, but are not limited to, random access memory (RAM), read only memory (ROM), electrically erasable programmable read only memory (EEPROM), flash memory or other memory technology, compact disk read only memory (CD-ROM), digital versatile disk (DVD), Blu-ray disc (BD) or other optical disk storage, magnetic cassettes, magnetic tape, magnetic disk storage or other magnetic storage devices, solid state drives or other solid state storage devices, or other tangible and/or non-transitory media which can be used to store desired information. In this regard, the terms “tangible” or “non-transitory” herein as applied to storage, memory or computer-readable media, are to be understood to exclude only propagating transitory signals per se as modifiers and do not relinquish rights to all standard storage, memory or computer-readable media that are not only propagating transitory signals per se.

Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

With reference again to FIG. 10, the example environment 1000 for implementing various embodiments described herein includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes ROM 1010 and RAM 1012. A basic input/output system (BIOS) can be stored in a non-volatile memory such as ROM, erasable programmable read only memory (EPROM), EEPROM, which BIOS contains the basic routines that help to transfer information between elements within the computer 1002, such as during startup. The RAM 1012 can also include a high-speed RAM such as static RAM for caching data.

The computer 1002 further includes an internal hard disk drive (HDD) 1014 (e.g., EIDE, SATA, SAS, NVME), one or more external storage devices 1016 (e.g., a magnetic floppy disk drive (FDD), a memory stick or flash drive reader, a memory card reader, etc.) and an optical disk drive 1020 (e.g., which can read or write from a CD-ROM disc, a DVD, a BD, etc.). While the internal HDD 1014 is illustrated as located within the computer 1002, the internal HDD 1014 can also be configured for external use in a suitable chassis (not shown). Additionally, while not shown in environment 1000, a solid state drive (SSD) could be used in addition to, or in place of, an HDD 1014. The HDD 1014, external storage device(s) 1016 and optical disk drive 1020 can be connected to the system bus 1008 by an HDD interface 1024, an external storage interface 1026 and an optical drive interface 1028, respectively. The interface 1024 for external drive implementations can include at least one or both of Universal Serial Bus (USB) and Institute of Electrical and Electronics Engineers (IEEE) 1394 interface technologies. Other external drive connection technologies are within contemplation of the embodiments described herein.

The drives and their associated computer-readable storage media provide nonvolatile storage of data, data structures, computer-executable instructions, and so forth. For the computer 1002, the drives and storage media accommodate the storage of any data in a suitable digital format. Although the description of computer-readable storage media above refers to respective types of storage devices, it should be appreciated by those skilled in the art that other types of storage media which are readable by a computer, whether presently existing or developed in the future, could also be used in the example operating environment, and further, that any such storage media can contain computer-executable instructions for performing the methods described herein.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. The systems and methods described herein can be implemented utilizing various commercially available operating systems or combinations of operating systems.

Computer 1002 can optionally comprise emulation technologies. For example, a hypervisor (not shown) or other intermediary can emulate a hardware environment for operating system 1030, and the emulated hardware can optionally be different from the hardware illustrated in FIG. 10. In such an embodiment, operating system 1030 can comprise one virtual machine (VM) of multiple VMs hosted at computer 1002. Furthermore, operating system 1030 can provide runtime environments, such as the Java runtime environment or the .NET framework, for applications 1032. Runtime environments are consistent execution environments that allow applications 1032 to run on any operating system that includes the runtime environment. Similarly, operating system 1030 can support containers, and applications 1032 can be in the form of containers, which are lightweight, standalone, executable packages of software that include, e.g., code, runtime, system tools, system libraries and settings for an application.

Further, computer 1002 can be enable with a security module, such as a trusted processing module (TPM). For instance with a TPM, boot components hash next in time boot components, and wait for a match of results to secured values, before loading a next boot component. This process can take place at any layer in the code execution stack of computer 1002, e.g., applied at the application execution level or at the operating system (OS) kernel level, thereby enabling security at any level of code execution.

A user can enter commands and information into the computer 1002 through one or more wired/wireless input devices, e.g., a keyboard 1038, a touch screen 1040, and a pointing device, such as a mouse 1042. Other input devices (not shown) can include a microphone, an infrared (IR) remote control, a radio frequency (RF) remote control, or other remote control, a joystick, a virtual reality controller and/or virtual reality headset, a game pad, a stylus pen, an image input device, e.g., camera(s), a gesture sensor input device, a vision movement sensor input device, an emotion or facial detection device, a biometric input device, e.g., fingerprint or iris scanner, or the like. These and other input devices are often connected to the processing unit 1004 through an input device interface 1044 that can be coupled to the system bus 1008, but can be connected by other interfaces, such as a parallel port, an IEEE 1394 serial port, a game port, a USB port, an IR interface, a BLUETOOTH® interface, etc.

A monitor 1046 or other type of display device can be also connected to the system bus 1008 via an interface, such as a video adapter 1048. In addition to the monitor 1046, a computer typically includes other peripheral output devices (not shown), such as speakers, printers, etc.

The computer 1002 can operate in a networked environment using logical connections via wired and/or wireless communications to one or more remote computers, such as a remote computer(s) 1050. The remote computer(s) 1050 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1052 is illustrated. The logical connections depicted include wired/wireless connectivity to a local area network (LAN) 1054 and/or larger networks, e.g., a wide area network (WAN) 1056. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 can be connected to the local network 1054 through a wired and/or wireless communication network interface or adapter 1058. The adapter 1058 can facilitate wired or wireless communication to the LAN 1054, which can also include a wireless access point (AP) disposed thereon for communicating with the adapter 1058 in a wireless mode.

When used in a WAN networking environment, the computer 1002 can include a modem 1060 or can be connected to a communications server on the WAN 1056 via other means for establishing communications over the WAN 1056, such as by way of the Internet. The modem 1060, which can be internal or external and a wired or wireless device, can be connected to the system bus 1008 via the input device interface 1044. In a networked environment, program modules depicted relative to the computer 1002 or portions thereof, can be stored in the remote memory/storage device 1052. It will be appreciated that the network connections shown are example and other means of establishing a communications link between the computers can be used.

When used in either a LAN or WAN networking environment, the computer 1002 can access cloud storage systems or other network-based storage systems in addition to, or in place of, external storage devices 1016 as described above. Generally, a connection between the computer 1002 and a cloud storage system can be established over a LAN 1054 or WAN 1056 e.g., by the adapter 1058 or modem 1060, respectively. Upon connecting the computer 1002 to an associated cloud storage system, the external storage interface 1026 can, with the aid of the adapter 1058 and/or modem 1060, manage storage provided by the cloud storage system as it would other types of external storage. For instance, the external storage interface 1026 can be configured to provide access to cloud storage sources as if those sources were physically connected to the computer 1002.

The computer 1002 can be operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, store shelf, etc.), and telephone. This can include Wireless Fidelity (Wi-Fi) and BLUETOOTH® wireless technologies. Thus, the communication can be a predefined structure as with a conventional network or simply an ad hoc communication between at least two devices.

The above description includes non-limiting examples of the various embodiments. It is, of course, not possible to describe every conceivable combination of components or methodologies for purposes of describing the disclosed subject matter, and one skilled in the art may recognize that further combinations and permutations of the various embodiments are possible. The disclosed subject matter is intended to embrace all such alterations, modifications, and variations that fall within the spirit and scope of the appended claims.

With regard to the various functions performed by the above described components, devices, circuits, systems, etc., the terms (including a reference to a “means”) used to describe such components are intended to also include, unless otherwise indicated, any structure(s) which performs the specified function of the described component (e.g., a functional equivalent), even if not structurally equivalent to the disclosed structure. In addition, while a particular feature of the disclosed subject matter may have been disclosed with respect to only one of several implementations, such feature may be combined with one or more other features of the other implementations as may be desired and advantageous for any given or particular application.

The terms “exemplary” and/or “demonstrative” as used herein are intended to mean serving as an example, instance, or illustration. For the avoidance of doubt, the subject matter disclosed herein is not limited by such examples. In addition, any embodiment or design described herein as “exemplary” and/or “demonstrative” is not necessarily to be construed as preferred or advantageous over other embodiments or designs, nor is it meant to preclude equivalent structures and techniques known to one skilled in the art. Furthermore, to the extent that the terms “includes,” “has,” “contains,” and other similar words are used in either the detailed description or the claims, such terms are intended to be inclusive—in a manner similar to the term “comprising” as an open transition word—without precluding any additional or other elements.

The term “or” as used herein is intended to mean an inclusive “or” rather than an exclusive “or.” For example, the phrase “A or B” is intended to include instances of A, B, and both A and B. Additionally, the articles “a” and “an” as used in this application and the appended claims should generally be construed to mean “one or more” unless either otherwise specified or clear from the context to be directed to a singular form.

The term “set” as employed herein excludes the empty set, i.e., the set with no elements therein. Thus, a “set” in the subject disclosure includes one or more elements or entities. Likewise, the term “group” as utilized herein refers to a collection of one or more entities.

The terms “first,” “second,” “third,” and so forth, as used in the claims, unless otherwise clear by context, is for clarity only and doesn't otherwise indicate or imply any order in time. For instance, “a first determination,” “a second determination,” and “a third determination,” does not indicate or imply that the first determination is to be made before the second determination, or vice versa, etc.

The description of illustrated embodiments of the subject disclosure as provided herein, including what is described in the Abstract, is not intended to be exhaustive or to limit the disclosed embodiments to the precise forms disclosed. While specific embodiments and examples are described herein for illustrative purposes, various modifications are possible that are considered within the scope of such embodiments and examples, as one skilled in the art can recognize. In this regard, while the subject matter has been described herein in connection with various embodiments and corresponding drawings, where applicable, it is to be understood that other similar embodiments can be used or modifications and additions can be made to the described embodiments for performing the same, similar, alternative, or substitute function of the disclosed subject matter without deviating therefrom. Therefore, the disclosed subject matter should not be limited to any single embodiment described herein, but rather should be construed in breadth and scope in accordance with the appended claims below.

What is claimed is:

1. A system, comprising:
a memory that stores executable components; and
a processor that executes the executable components stored in the memory, wherein the executable components comprise:
a resource monitoring component that determines operational statuses of resource components of a node device operating in a computing cluster associated with the system; and
a role selection component that selects an operational role for the node device in response to the resource monitoring component identifying a change to a first operational status, of the operational statuses and corresponding to a first resource component of the resource components, the operational role being selected by the role selection component based on second resource components, of the resource components, that are determined by the resource monitoring component to be operational, wherein the operational role specifies operations to be performed by the node device in the computing cluster.

2. The system of claim 1, wherein the second resource components comprise the first resource component, and wherein the change to the first operational status corresponds to the node device connecting to the computing cluster.

3. The system of claim 1, wherein the change to the first operational status corresponds to a failure of the first resource component.

4. The system of claim 3, wherein the operational role is a storage role, wherein the first resource component is a byte-addressable storage medium that stores a write journal for the node device, and wherein the role selection component assigns the write journal to a block-addressable storage medium of the node device in response to the failure of the byte-addressable storage medium.

5. The system of claim 3, wherein the first resource component is a storage medium that stores a write journal for the node device, and wherein the role selection component alters the operational role of the node device from a storage role to a processing role in response to the failure of the storage medium.

6. The system of claim 5, wherein the storage role comprises lock management operations, and wherein the processing role excludes the lock management operations.

7. The system of claim 1, wherein the role selection component selects the operational role from a group of operational roles, comprising the operational role, that are supported by the second resource components.

8. The system of claim 7, wherein the role selection component selects the operational role based on a decision tree.

9. The system of claim 7, wherein the role selection component selects the operational role based on computing resources available to the node device via the second resource components.

10. The system of claim 1, wherein the resource components are selected from a group comprising hardware components and software components.

11. The system of claim 1, wherein the role selection component selects a backup role for the node device in response to the resource monitoring component determining that the node device comprises an interface to a tape library unit and in further response to the resource monitoring component determining that the interface is operational.

12. A method, comprising:
monitoring, by a system comprising a processor, operational states of resource elements of a computing device in a computing cluster; and
in response to determining, via the monitoring, that a first resource element of the resource elements has transitioned between a functioning operational state and a non-functioning operational state, assigning, by the system, a computational function to the computing device based on second resource elements, of the resource elements, having the functioning operational state.

13. The method of claim 12, further comprising:
determining, by the system, that the first resource element has transitioned from the non-functioning operational state to the functioning operational state in response to the computing device connecting to the computing cluster.

14. The method of claim 12, wherein the second resource elements do not comprise the first resource element, and wherein the method further comprises:
determining, by the system, that the first resource element has transitioned from the functioning operational state to the non-functioning operational state in response a failure of the first resource element.

15. The method of claim 12, wherein the assigning of the computational function is based on a decision tree.

16. The method of claim 12, wherein the computational function is selected from a group of functions comprising a storage function, a processing function, and a backup function.

17. A non-transitory machine-readable medium comprising computer executable instructions that, when executed by a processor, facilitate performance of operations, the operations comprising:
tracking performance metrics for resources associated with a node device of a computing cluster;
determining, via the tracking, that a resource of the resources has transitioned between a functional state and a non-functional state; and
in response to the determining, causing the node device to perform a first function, the first function being different from a second function performed by the node device before the determining.

18. The non-transitory machine-readable medium of claim 17, wherein the determining comprises determining that the resource has transitioned from the non-functional state to the functional state in response to the node device being determined to have attached to the computing cluster.

19. The non-transitory machine-readable medium of claim 17, wherein the determining comprises determining that the resource has transitioned from the functional state to the non-functional state in response to the resource being determined to have failed.

20. The non-transitory machine-readable medium of claim 17, wherein the first function is selected from a group of functions comprising a storage function, a processing assistance function, and a backup function.
